(19) United States
(12) Patent Application Publication
(10) Pub. No.: US 2014/0042681 A1
(43) Pub. Date: Feb. 13, 2014

(54) UNIVERSAL CARBURETOR WORK STAND WITH USER RECONFIGURABLE SUPPORT STANCHIONS

(71) Applicant: Christianna Mikhal Kooney, Slidell, LA (US)

(72) Inventor: Christianna Mikhal Kooney, Slidell, LA (US)

(21) Appl. No.: 13/779,677

(22) Filed: Feb. 27, 2013

Related U.S. Application Data
(60) Provisional application No. 61/682,178, filed on Aug. 10, 2012.

(51) Int. Cl. B25B 11/00

(52) U.S. Cl. CPC B25B 11/002
USPC 269/8; 29/559

(57) ABSTRACT

A carburetor work stand allows the user to reconfigure the carburetor support stanchions, thereby allowing any carburetor, regardless of vintage, type, size or mounting bolt pattern, to be supported by the work stand.

### CROSS-REFERENCE TO RELATED APPLICATION

This application claims the benefit of priority of U.S. provisional application No. 61/682,178, filed Aug. 10, 2012, the contents of which are herein incorporated by reference.

### BACKGROUND OF THE INVENTION

The present invention relates to engine repair accessories and, more particularly, to a universal work stand with user reconfigurable support stanchions for internal combustion engine carburetors of varying size and bolt patterns.

Presently available carburetor repair stands support only a specific carburetor or modern, common range of carburetor types, sizes and bolt patterns. Vintage and uncommon carburetor types cannot be supported with these available carburetor work stands. Therefore, in order to service a range of carburetors, a user would have to possess multiple styles of carburetor work stands.

As can be seen, there is a need for a universal work stand for internal combustion engine carburetors of varying size and bolt patterns.

### SUMMARY OF THE INVENTION

In one aspect of the present invention, a carburetor work stand comprises a magnetically attractive base plate; a plurality of support stanchions; a protrusion on a top of the support stanchions; and a magnet disposed in a hole on a bottom portion of the support stanchion, the magnet securing the support stanchion on the steel base plate.

In another aspect of the present invention, a method for supporting a carburetor while providing full range of carburetor linkage and assembly movement comprises positioning a plurality of support stanchions on a magnetically attractive base plate, the plurality of support stanchions having a magnet in a bottom portion thereof to attract the support stanchions to the base plate; and supporting the carburetor on the plurality of support stanchions by inserting protrusions on the top of each of the plurality of support stanchions through carburetor mounting holes in the carburetor.

These and other features, aspects and advantages of the present invention will become better understood with reference to the following drawings, description and claims.

### BRIEF DESCRIPTION OF THE DRAWINGS

FIG. 1 is a perspective view of a user reconfigurable carburetor work stand, in use supporting a carburetor, according to an exemplary embodiment of present invention;

FIG. 2 is a perspective view of the user reconfigurable carburetor work stand of FIG. 1;

FIG. 3 is a top perspective view of a support stanchion of the user reconfigurable carburetor work stand of FIG. 1;

FIG. 4 is a bottom perspective view of the support stanchion of FIG. 3; and

FIG. 5 is a cross-sectional view taken along line 5-5 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a carburetor work stand that allows the user to reconfigure the carburetor support stanchions, thereby allowing any carburetor, regardless of vintage, type, size or mounting bolt pattern, to be supported by the work stand.

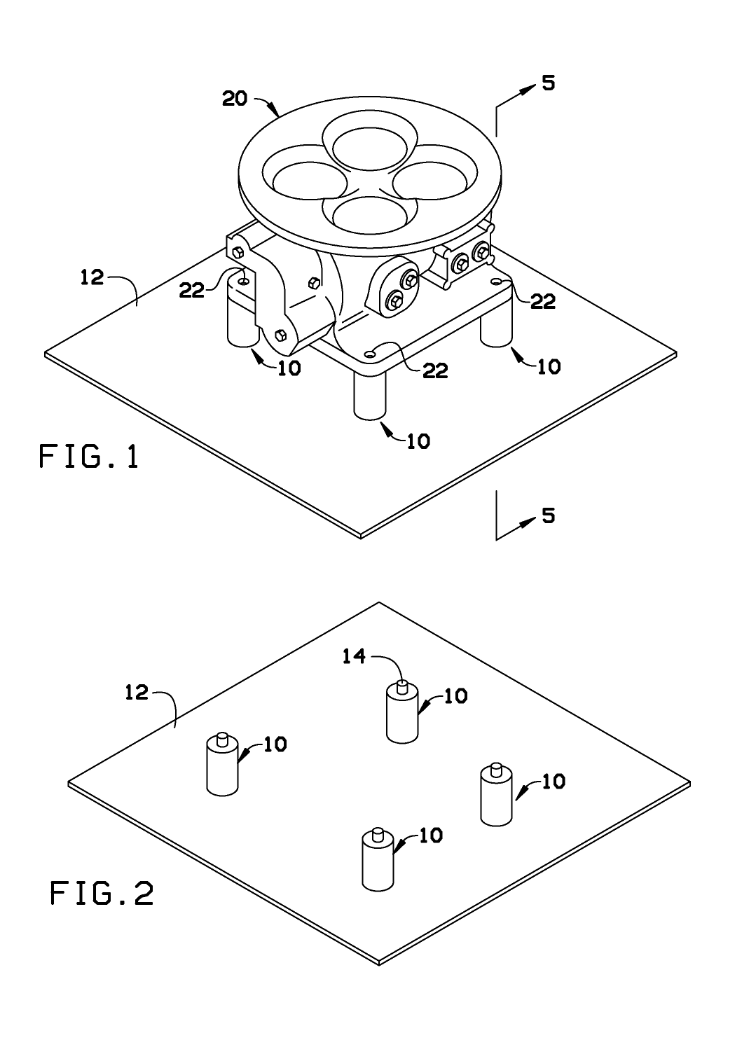

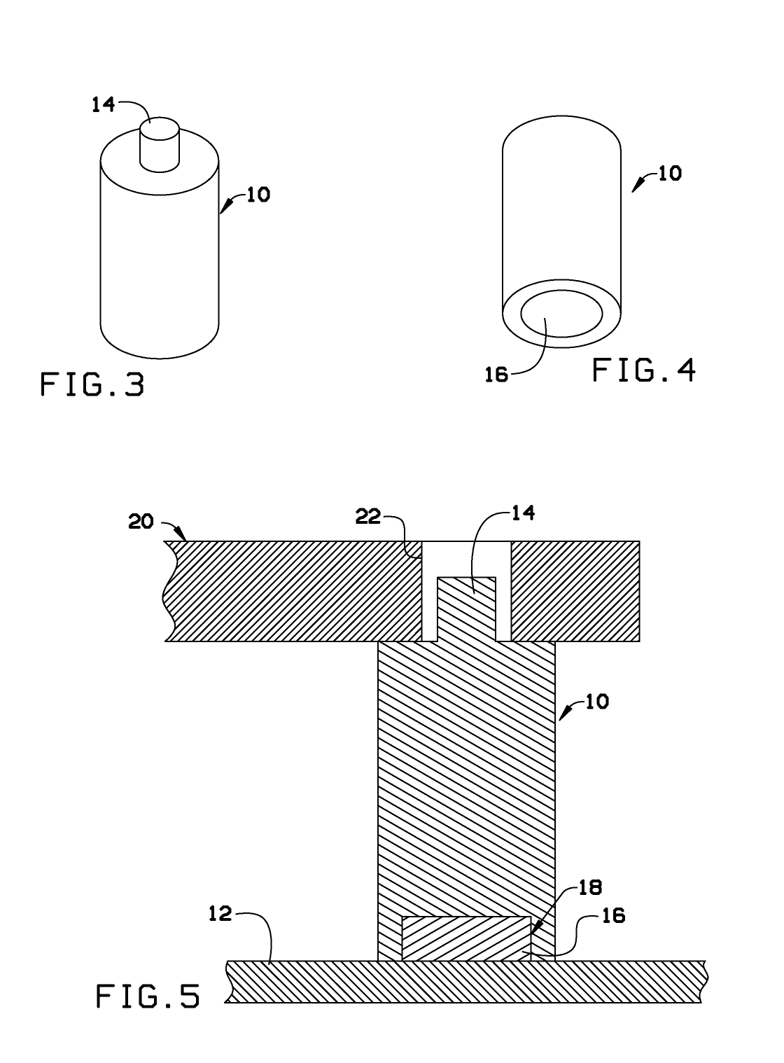

Referring now to FIGS. 1 through 5, a carburetor work stand can include a steel plate 12 that has a surface-ground flat face and serves as the base for the carburetor work stand. A plurality of magnetic support stanchions 10 can be made of a soft metal, such as aluminum, brass, or the like, and can be lathe turned to a shape that includes a protrusion 14 at the top and a hole 18 in the bottom. Typically, each of the plurality of magnetic support stanchions 10 are identical to each other. In some embodiments, the magnetic support stanchions 10 can be made in different shapes, thicknesses, heights or the like.

A magnet 16 can be press fit into the hole 18 machined into the magnetic support stanchions 10. The magnet 16 can be, for example, a neodymium magnet. The magnets 16 can be of sufficient magnetic strength to hold the stanchion 10 in position on the steel plate 12 and allow the protrusion 14 to engage in a mounting bolt pattern 22 of a carburetor 20 to be serviced. The support stanchions 10 hold and elevate the carburetor 20 so that the full range of carburetor linkage and assembly movements are allowed during service.

Assemblies (carburetor work stands) can be created by combining the steel plate 12 with a plurality of magnetic support stanchions 10. The support stanchions 10 can be attached to and repositionable on the steel plate 12.

Rubber feet (not shown) can be added to the bottom of the base plate 12 for stability and to prevent the carburetor work stand from sliding on a work surface.

In some embodiments, suggested support stanchion positions can be indicated, by painting, chemical etching, laser etching, or the like, on the steel base plate surface for servicing common or popularly used carburetors.

It should be understood, of course, that the foregoing relates to exemplary embodiments of the invention and that modifications may be made without departing from the spirit and scope of the invention as set forth in the following claims.

What is claimed is:

1. A carburetor work stand comprising:
a magnetically attractive base plate;
a plurality of support stanchions;
a protrusion on a top of the support stanchions; and
a magnet disposed in a hole on a bottom portion of the support stanchion, the magnet securing the support stanchion on the steel base plate.

2. The carburetor work stand of claim 1, wherein the plurality of support stanchions include four support stanchions.

3. The carburetor work stand of claim 1, wherein the protrusion has a size to fit into carburetor mounting holes of a carburetor mounted atop the plurality of support stanchions.

4. The carburetor work stand of claim 1, wherein the magnetically attractive base plate is a steel base plate.

5. A method for supporting a carburetor while providing full range of carburetor linkage and assembly movement, the method comprising:
positioning a plurality of support stanchions on a magnetically attractive base plate, the plurality of support stanchions having a magnet in a bottom portion thereof to attract the support stanchions to the base plate; and
supporting the carburetor on the plurality of support stanchions by inserting protrusions on the top of each of the plurality of support stanchions through carburetor mounting holes in the carburetor.

6. The method of claim 5, wherein the plurality of support stanchions include four support stanchions.

7. The method of claim 5, wherein the magnetically attractive base plate is a steel base plate.
